(19) United States
(12) Patent Application Publication
(10) Pub. No.: US 2026/0350753 A1
(43) Pub. Date: Nov. 5, 2026

(54) SELF-SUPERVISED LEARNING METHOD AND SYSTEM FOR SATELLITE IMAGE ENHANCEMENT MODEL

(71) Applicant: Korea Electronics Technology Institute, Seongnam-si (KR)

(72) Inventors: Choong Sang CHO, Seongnam-si (KR); Gui Sik KIM, Seongnam-si (KR); Young Han LEE, Seongnam-si (KR); Tae Woo KIM, Seongnam-si (KR)

(73) Assignee: Korea Electronics Technology Institute, Seongnam-si (KR)

(21) Appl. No.: 19/255,912

(22) Filed: Jun. 30, 2025

(30) Foreign Application Priority Data
Apr. 30, 2025 (KR) 10-2025-0057367

(51) Int. Cl. G06T 5/60; G06T 5/70; G06V 20/13

(52) U.S. Cl. CPC G06T 5/60; G06T 5/70; G06V 20/13

(57) ABSTRACT

Provided is a self-supervised learning method and system of a satellite image enhancement model. An image enhancement model training system according to an embodiment may generate a plurality of different enhanced images by inputting an acquired image to a plurality of different image enhancement models constituting an image enhancement model group, may select one of the generated enhanced images, and may train a target image enhancement model by using the acquired image as input data and using the selected image as right answer data. Accordingly, it is possible to perform self-supervised learning for an image enhancement model, so that the image enhancement model may be trained with high accuracy without efforts and difficulty in acquiring training datasets.

### CROSS-REFERENCE TO RELATED APPLICATION(S) AND CLAIM OF PRIORITY

This application is based on and claims priority under 35 U.S.C. § 119 to Korean Patent Application No. 10-2025-0057367, filed on Apr. 30, 2025, in the Korean Intellectual Property Office, the disclosure of which is herein incorporated by reference in its entirety.

### BACKGROUND

### Field

The disclosure relates to visual intelligence-based image enhancement, and more particularly, to a method for training a visual intelligence model for enhancing quality of images by self-supervised learning.

### Description of Related Art

In order to enhance the quality of satellite images, haze, clouds, etc. appearing in satellite images should be removed. Recently, many researches and development are being made to remove haze, etc. from satellite images using deep learning-based visual intelligence models.

To train a visual intelligence model, satellite images with haze and satellite images without haze that are to be used as labeled data may be required. However, it is very difficult or practically impossible to acquire multiple haze-free satellite images.

Therefore, satellite images with haze, etc. may be synthesized by arbitrarily combining haze, clouds, etc. with haze-free satellite images, and may be used as training data. However, good performance may not be guaranteed due to problems of overfitting, etc. caused by limitations of images augmented through synthesis from a small number of satellite images.

Accordingly, there is a need for a method for enabling self-supervised learning rather than supervised learning in training visual intelligence models for enhancing the quality of satellite images.

### SUMMARY

The disclosure has been developed in order to solve the above-described problems, and an object of the disclosure is to provide a method and a system for training a satellite image enhancement model by self-supervised learning, as a solution to reduce efforts and difficulty in acquiring training datasets for supervised learning of satellite image enhancement models.

According to an embodiment of the disclosure to achieve the above-described object, an image enhancement model training system may include: an acquisition unit configured to acquire an image; a generation unit configured to generate a plurality of different enhanced images by inputting the image acquired by the image acquisition unit to a plurality of different image enhancement models constituting an image enhancement model group; a selection unit configured to select one of the generated enhanced images; and a training unit configured to train a target image enhancement model by using the image acquired by the acquisition unit as input data and using the image selected by the selection unit as right answer data.

The training unit may add the trained target image enhancement model to the image enhancement model group.

The training unit may continue to train the target image enhancement model even after the target image enhancement model is added to the image enhancement model group.

The training unit may add the trained target image enhancement model to the image enhancement model group when the accuracy of the trained target image enhancement model exceeds a threshold.

The generation unit may remove some of the image enhancement models constituting the image enhancement model group from the image enhancement model group.

The generation unit may remove an image enhancement model that has a lowest rate of selecting an enhanced image by the selection unit from the image enhancement model group.

The selection unit may select an enhanced image that has a lowest similarity to the image acquired by the acquisition unit among the generated enhanced images.

The selection unit may measure the similarity by at least one of mean square error (MSE), cosine-similarity, structural similarity index measure (SSIM).

Image enhancement may include at least one of noise removal, haze removal, and cloud removal, and the image may be a satellite image.

According to another aspect of the disclosure, an image enhancement model training method may include: acquiring, by an image enhancement model training system, an image; generating, by the image enhancement model training system, a plurality of different enhanced images by inputting the acquired image to a plurality of different image enhancement models constituting an image enhancement model group; selecting, by the image enhancement model training system, one of the generated enhanced images; and training, by the image enhancement model training system, a target image enhancement model by using the acquired image as input data and using the selected image as right answer data.

According to still another aspect of the disclosure, an image enhancement system may include: an acquisition unit configured to acquire an image; and an enhancement unit configured to generate an enhanced image by inputting the image acquired by the image acquisition unit to an image enhancement model, and the image enhancement model may generate a plurality of different enhanced images by inputting an input image to a plurality of different image enhancement models constituting an image enhancement model group, may select one of the generated enhanced images, and may be trained by using the input image as input data and using the selected image as right answer data.

As described above, according to embodiments of the disclosure, one of the enhanced images generated in the pre-trained image enhancement model group for the input image may be selected as right answer data, and self-supervised learning may be performed for an image enhancement model, so that the image enhancement model may be trained with high accuracy without efforts and difficulty in acquiring training datasets.

In addition, according to embodiments of the disclosure, during the training of an image enhancement model, the image enhancement model may be added as a configuration of the image enhancement model group to generate an enhanced image which will become right answer data, thereby contributing to its own training and growth and dramatically increasing the accuracy of training.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a satellite image enhancement model training system according to an embodiment of the disclosure;

FIG. 2 is a view illustrating a detailed configuration of an enhanced image generation unit;

FIG. 3 is a view illustrating an example of generating enhanced images;

FIG. 4 is a view illustrating an inference database (DB) storage structure;

FIG. 5 is a view provided to explain operations of an enhanced image selection unit;

FIG. 6 is a view illustrating techniques for determining image similarity of the enhanced image selection unit;

FIG. 7 is a view provided to explain operations of an image enhancement model training unit;

FIG. 8 is a view illustrating a satellite image enhancement model training method according to another embodiment of the disclosure; and

FIG. 9 is a view illustrating a self-supervised learning-based satellite image enhancement system according to still another embodiment of the disclosure.

### DETAILED DESCRIPTION

Hereinafter, the disclosure will be described in more detail with reference to the accompanying drawings.

Embodiments of the disclosure propose a self-supervised learning method and system of a satellite image enhancement model. The disclosure relates to a technique that selects, as right answer data, one of the enhanced images generated by a pre-trained satellite image enhancement model group for an input satellite image, and trains an image enhancement model by self-supervised learning.

According to embodiments of the disclosure, during the training of an image enhancement model, the image enhancement model may be added as a configuration of the image enhancement model group to be involved in generating an enhanced image that will become right answer data, thereby contributing to its own training and growth and dramatically increasing the accuracy of training.

Compared to related-art technologies where it is essential to acquire training datasets for satellite image enhancement, which is very difficult and requires many efforts and is practically impossible, embodiments of the disclosure may train a satellite image enhancement model with high accuracy without acquiring training datasets.

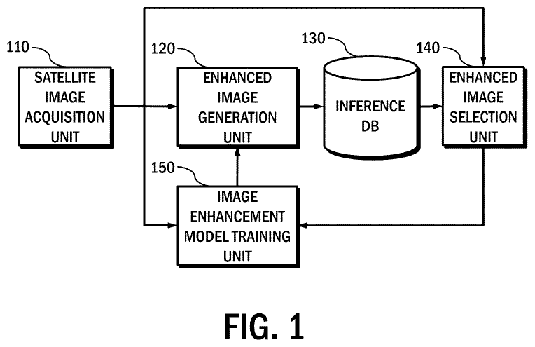

FIG. 1 is a view illustrating a configuration of a satellite image enhancement model training system according to an embodiment of the disclosure. The training system according to an embodiment may be a system for training a satellite image enhancement model by self-supervised learning, and may include a satellite image acquisition unit 110, an enhanced image generation unit 120, an inference DB 130, an enhanced image selection unit 140, and an image enhancement model training unit 150 as shown in the drawing.

The satellite image acquisition unit 110 may be configured to acquire a satellite image which is shot by a satellite. The satellite image acquisition unit 110 may acquire a satellite image by loading a satellite image stored in an internal repository or receiving a satellite image from an external server or the like through a communication means. The satellite image acquired by the satellite image acquisition unit 110 may be inputted to the enhanced image generation unit 120.

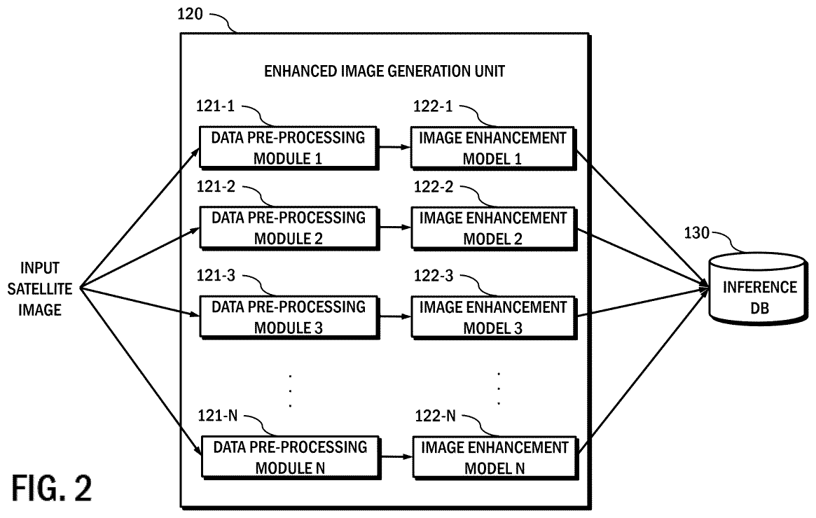

The enhanced image generation unit 120 may generate a plurality of different enhanced images from the satellite image acquired by the satellite image acquisition unit 110. A detailed configuration of the enhanced image generation unit 120 to achieve this is illustrated in FIG. 2. As shown in the drawing, the enhanced image generation unit 120 may include N data pre-processing modules 121-1, 2, 3, . . . , N, and N image enhancement models 122-1, 2, 3, . . . , N.

The N data pre-processing modules 121-1, 2, 3, . . . , N may perform typical pre-processing that is required for the satellite image inputted from the satellite image acquisition unit 110, and may transmit the images to the N image enhancement models 122-1, 2, 3, . . . , N which are matched therewith.

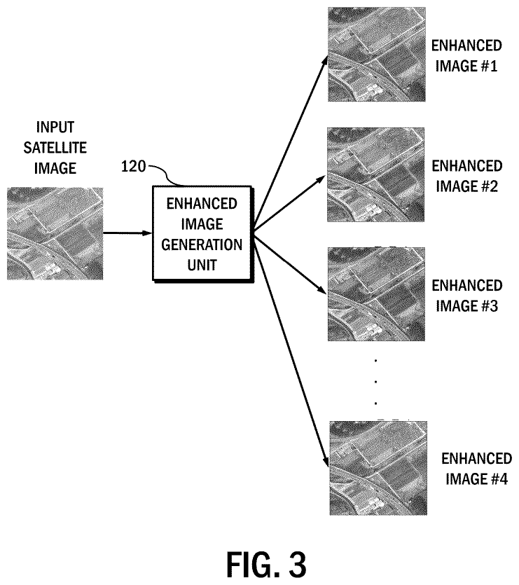

The N image enhancement models 122-1, 2, 3, . . . , N may be deep learning-based intelligence models that are pre-trained to receive a satellite image and to output enhanced images by performing image enhancement such as haze removal, noise removal, clouds removal, etc. In embodiments of the disclosure, the N image enhancement models 122-1, 2, 3, . . . , N may be expressed as forming an image enhancement model group. Since the N image enhancement models 122-1, 2, 3, . . . , N constituting the image enhancement model group are different models, the enhanced images that are generated by the N image enhancement models 122-1, 2, 3, . . . , N may be different from one another although the input satellite image is the same. FIG. 3 illustrates an example of a result of generating N enhanced images from a single input satellite image.

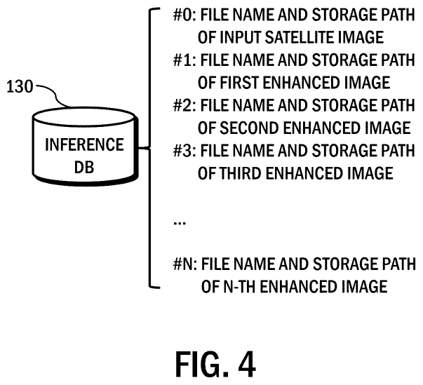

The enhanced images that are generated by the N image enhancement models 122-1, 2, 3, . . . , N may be matched with information related to the satellite image inputted from the satellite image acquisition unit 110, and may be stored in the inference DB 130. Specifically, as shown in FIG. 4, in the inference DB 130, the input satellite image may be stored with its file name and storage path, and the plurality of enhanced images generated from the input satellite image may be stored with their file names and storage paths.

References are made back to FIG. 1. The enhanced image selection unit 140 may select one of the plurality of enhanced images generated by the enhanced image generation unit 120 with reference to the inference DB 130.

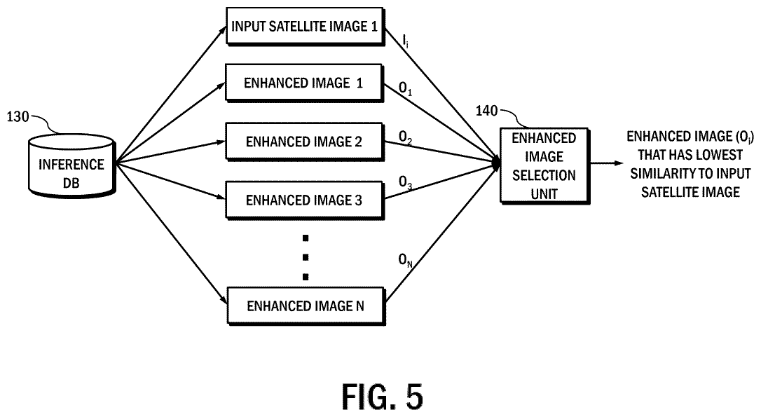

Specifically, as shown in FIG. 5, the enhanced image selection unit 140 may acquire the input satellite image Iᵢ and the N enhanced images O_{1, 2, 3, . . . , N} with reference to the file names and the storage paths stored in the inference DB 130, and may select an enhanced image Oᵢ that has the lowest similarity to the input satellite image Iᵢ among the N enhanced images O_{1, 2, 3, . . . , N}.

As an image is more enhanced, the image has a great difference from the input image and has lower similarity, and as an image is less enhanced, the image has a small difference from the input image and has higher similarity. In embodiments of the disclosure, an image with the most image enhancements may be treated and utilized as the best enhanced image.

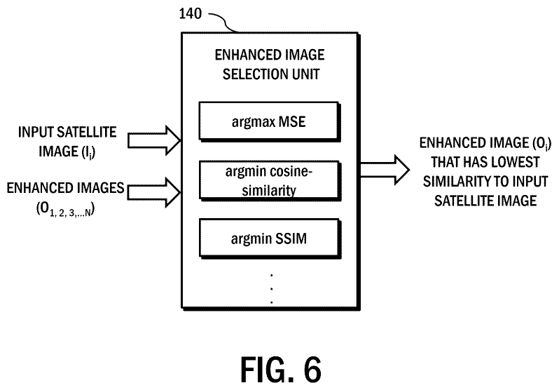

Techniques for determining similarity by the enhanced image selection unit 140 are illustrated in FIG. 6. As shown in the drawing, the enhanced image selection unit 140 may calculate similarity/difference between the input satellite image Iᵢ and the N enhanced images O_{1, 2, 3, . . . , N} through 1) argmax mean square error (MSE), 2) argmin cosine-similarity, 3) argmin structural similarity index measure (SSIM), and may select an enhanced image Oᵢ that has the lowest similarity to, that is, has the greatest difference from the input satellite image Iᵢ among the N enhanced images O_{1, 2, 3, . . . , N}.

For example, when argmax MSE is utilized, MSEs between the input satellite image Iᵢ and the N enhanced images O_{1, 2, 3, . . . , N} may be calculated, respectively, and an enhanced image Oᵢ that has the greatest MSE may be selected.

References are made back to FIG. 1. The image enhancement model training unit 150 may train a target image enhancement model by using the satellite image Iᵢ inputted from the satellite image acquisition unit 110 as input data, and using the enhanced image Oᵢ selected by the enhanced image selection unit 140 as right answer data.

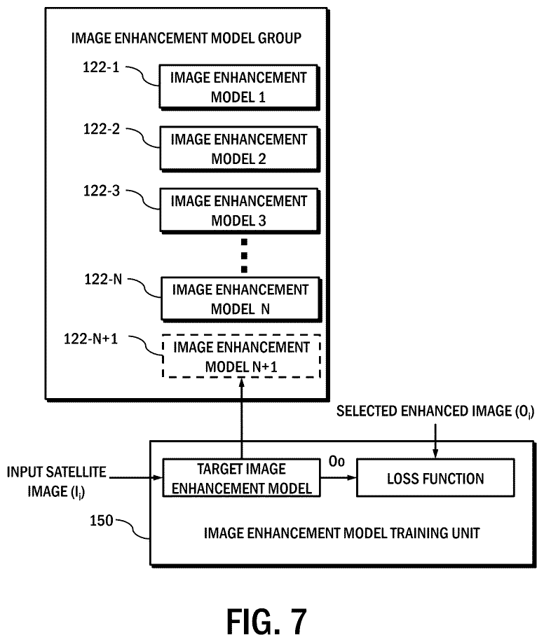

Specifically, as shown in the lower part of FIG. 7, the image enhancement model training unit 150 may train the target image enhancement model by inputting the input satellite image Iᵢ to the target image enhancement model to generate an enhanced image Oₒ, and updating the parameters of the target image enhancement model in such a way that a loss between the generated enhanced image Oₒ and the enhanced image Oᵢ that is selected as right answer data is reduced.

When the target image enhancement model is trained to some extent, the image enhancement model training unit 150 may add the target image enhancement model to the image enhancement model group that is established in the enhanced image generation unit 120 as shown in the upper part of FIG. 7. The target image enhancement model may be added when the number of times of training exceeds a defined number or the accuracy of the target image enhancement model exceeds a threshold. Accordingly, one more image enhancement model is added to the image enhancement model group of the enhanced image generation unit 120, such that the total number of image enhancement models is N+1.

Even when the target image enhancement model is added to the image enhancement model group, the image enhancement model training unit 150 may continue to train the target image enhancement model. In this case, the target image enhancement model may generate training data to use for its own training, and may lead its own growth. Furthermore, it is possible to further add the additionally trained target image enhancement model to the image enhanced model group.

The enhanced image generation unit 120 may remove an image enhancement model that constitutes the image enhancement model group. For example, if the number of image enhancement models exceeds a defined number, the excess number of image enhancement models may be removed. An image enhancement model to be removed may be a model that has a low selection rate of a recent enhanced image, as this image enhancement model may be considered to have poor image enhancement performance and therefore may not generate training data of good quality.

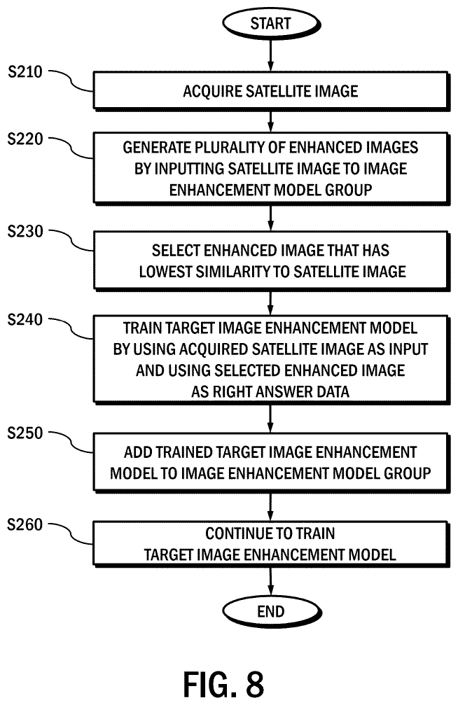

FIG. 8 is a flowchart illustrating a satellite image enhancement model training method according to another embodiment of the disclosure.

To train a satellite image enhancement model by self-supervised learning, the satellite image acquisition unit 110 may acquire a satellite image that is shot by a satellite (S210), and the enhanced image generation unit 120 may input the satellite image acquired in step S210 into the plurality of different image enhancement models constituting the image enhancement model group, respectively, thereby generating a plurality of different enhanced images (S220).

The enhanced image selection unit 140 may select an enhanced image Oᵢ that has the lowest similarity to the satellite image acquired in step S210 among the enhanced image generated in step S220 (S230).

The image enhancement model training unit 150 may train a target image enhancement model by using the satellite image acquired in step S210 as input data of the target image enhancement model, and using the enhanced image selected in step S230 as right answer data (S240).

When the target image enhancement model is trained to some extent, the image enhancement model training unit 150 may add the trained target image enhancement model to the image enhancement model group (S250), and thereafter, may continue to train the target image enhancement model (S260).

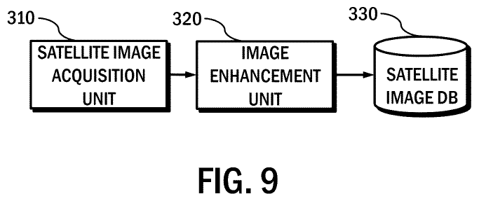

FIG. 9 is a view illustrating a configuration of a self-supervised learning-based satellite image enhancement system according to still another embodiment of the disclosure. The satellite image enhancement system according to an embodiment may include a satellite image acquisition unit 310, an image enhancement unit 320, and a satellite image DB 330 as shown in the drawing.

The satellite image acquisition unit 310 may be configured to acquire a satellite image which is shot by a satellite. The image enhancement unit 320 may generate an enhanced satellite image from which haze is removed, by inputting the image acquired by the satellite image acquisition unit 310 to an image enhancement model that is trained by self-supervised learning by the system proposed in FIG. 1 according to the method proposed in FIG. 8. The generated enhanced satellite image may be stored in the satellite image DB 330 and utilized.

Up to now, the self-supervised learning method and system of the satellite image enhancement model has been described in detail with reference to preferred embodiments.

In the above embodiments, one of the enhanced images generated in the pre-trained image enhancement model group for the input image may be selected as right answer data, and self-supervised learning may be performed for an image enhancement model, so that the image enhancement model may be trained with high accuracy without efforts and difficulty in acquiring training datasets.

In addition, during the training of an image enhancement model, the image enhancement model may be added as a configuration of the image enhancement model group to generate an enhanced image which will become right answer data, thereby contributing to its own training and growth and dramatically increasing the accuracy of training.

The satellite image, removal of haze mentioned in the above embodiments are merely examples. The technical idea of the disclosure may be applicable to image enhancement other than haze removal for images other than the satellite image.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. An image enhancement model training system comprising:
an acquisition unit configured to acquire an image;
a generation unit configured to generate a plurality of different enhanced images by inputting the image acquired by the image acquisition unit to a plurality of different image enhancement models constituting an image enhancement model group;
a selection unit configured to select one of the generated enhanced images; and
a training unit configured to train a target image enhancement model by using the image acquired by the acquisition unit as input data and using the image selected by the selection unit as right answer data.

2. The image enhancement model training system of claim 1, wherein the training unit is configured to add the trained target image enhancement model to the image enhancement model group.

3. The image enhancement model training system of claim 2, wherein the training unit is configured to continue to train the target image enhancement model even after the target image enhancement model is added to the image enhancement model group.

4. The image enhancement model training system of claim 2, wherein the training unit is configured to add the trained target image enhancement model to the image enhancement model group when the accuracy of the trained target image enhancement model exceeds a threshold.

5. The image enhancement model training system of claim 2, wherein the generation unit is configured to remove some of the image enhancement models constituting the image enhancement model group from the image enhancement model group.

6. The image enhancement model training system of claim 5, wherein the generation unit is configured to remove an image enhancement model that has a lowest rate of selecting an enhanced image by the selection unit from the image enhancement model group.

7. The image enhancement model training system of claim 1, wherein the selection unit is configured to select an enhanced image that has a lowest similarity to the image acquired by the acquisition unit among the generated enhanced images.

8. The image enhancement model training system of claim 7, wherein the selection unit is configured to measure the similarity by at least one of mean square error (MSE), cosine-similarity, structural similarity index measure (SSIM).

9. The image enhancement model training system of claim 1, wherein image enhancement comprises at least one of noise removal, haze removal, and cloud removal, and
wherein the image is a satellite image.

10. An image enhancement model training method comprising:
acquiring, by an image enhancement model training system, an image;
generating, by the image enhancement model training system, a plurality of different enhanced images by inputting the acquired image to a plurality of different image enhancement models constituting an image enhancement model group;
selecting, by the image enhancement model training system, one of the generated enhanced images; and
training, by the image enhancement model training system, a target image enhancement model by using the acquired image as input data and using the selected image as right answer data.

11. An image enhancement system comprising:
an acquisition unit configured to acquire an image; and
an enhancement unit configured to generate an enhanced image by inputting the image acquired by the image acquisition unit to an image enhancement model,
wherein the image enhancement model is configured to: generate a plurality of different enhanced images by inputting an input image to a plurality of different image enhancement models constituting an image enhancement model group; select one of the generated enhanced images; and be trained by using the input image as input data and using the selected image as right answer data.
